(19) United States
(12) Patent Application Publication
(10) Pub. No.: US 2013/0111084 A1
(43) Pub. Date: May 2, 2013

(54) METHODS AND DEVICES FOR SINGLE LINK AGGREGATED BUSES

(71) Applicant: Feng Wang, San Diego, CA (US)

(72) Inventor: Feng Wang, San Diego, CA (US)

(73) Assignee: QUALCOMM Incorporated, San Diego, CA (US)

(21) Appl. No.: 13/286,420

(22) Filed: Nov. 1, 2011

(51) Int. Cl. G06F 3/00

(52) U.S. Cl. 710/54; 710/52

(57) ABSTRACT

An load balanced interconnect between a master device and slave devices, having a buffer coupling the master to the slave devices, and queuing access requests from the master to respective ones of the slaves. A load condition of the buffer is detected, a bypass buffer coupling the master to one or more of the slave devices is established, and access requests are moved from the buffer to the bypass buffer to change the load condition. Optionally a condition of slave devices is detected, and optionally the condition of the slave devices is changed by moving or reordering access requests in and among the buffer and the bypass buffer.

### FIELD OF DISCLOSURE

The present disclosure is related to increasing throughput in systems using bus aggregation buses, and more specifically, to the addition of a buffer for independently supporting access channel operations to a designated slave in a single link configuration.

### BACKGROUND

For systems using bus aggregation, attempting to conduct access operations over a single link between the buses presents a bottleneck particularly when a large number of access operation requests become queued for more than one slave device. If a predominant number of requests are directed to one slave device, and that device becomes overloaded, starvation can occur for the other slave devices.

Approaches to address the above described issues include using a dual link between the buses instead of single link. A dual link can be used to increase the bandwidth between the interconnects to avoid performance degradation and starvation. However, disadvantages can arise in that the use of a dual link generally increases the overhead associated with the aggregation system. Further, an overall increase in the interconnect routing efforts, increase in the area and power of the interconnects, and increase in timing closure efforts can be expected when using a dual link approach.

It would be desirable therefore to make use of a single link approach, while addressing the above described disadvantages associated with, for example, throughput reduction.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any aspect. Its sole purpose is to present some concepts of one or more aspects in a simplified, form as a prelude to the more detailed description that is presented below.

Exemplary embodiments provide load balancing for access requests from a master device to slave devices. In one aspect a buffer coupled between a master and slave devices receives and queues access requests, each associated with one of the slaves, and a condition of the buffer is determined or detected. The buffer may be a first buffer. The condition may be a backpressure condition. The condition may be a non-balance condition. The condition may be a load condition. Another buffer may be established and slave requests associated with one or more of the slave devices may be moved from the buffer to the other buffer. The other buffer may be a bypass buffer. The other buffer may be a second buffer. In one aspect, the other buffer may be deleted based on a condition, and the condition may be a condition of the first buffer. In one aspect a condition of one or more of the slave devices may be detected or determined and, based on the condition, access requests associated with the one or more slave devices may be moved from the buffer to the other buffer, or from the other buffer to the buffer, or queues of one or more of the buffer or other buffer may be reordered.

In one aspect, determining a non-balanced condition of the first buffer may include comparing an accumulated number of access requests in the first buffer to a given backpressure criterion.

According to one aspect, the method may include queuing in the first buffer the access requests received from the master, and moving identified second access requests to the second buffer may include queuing second access requests in the second buffer and, in a further aspect, a non-balanced condition of the second slave may be a starvation condition. In a still-further aspect, determining the starvation condition may include determining at least one of a queue position of second access requests queued in the first buffer or determining a queue position of second access requests queued in the second buffer.

According to certain exemplary embodiments, a method is provided for increasing throughput between a master and slaves, and the method may include determining an availability condition of a first and a second of the slaves, determining an accumulated number of queued access requests for the slaves queued in a first buffer coupled between the master and at least a first and a second of the slaves. First ones of the queued access requests may be associated with the first slave. According to one aspect, a method determines if the accumulated number is greater than a given value and the second slave is determined to be available and, if so, the method may identify second ones of the queued access requests in the first buffer associated with the second slave, establish a second buffer associated with the second slave, moving at least one of the second ones of the queued access requests to the second buffer.

In one aspect, the method of certain exemplary embodiments for increasing throughput between a master and slaves may further include identifying N ones of the queued access requests in the first buffer associated with respective N ones of the slaves, establishing N buffers, each coupled between the master and at least one of the respective N ones of the slaves, and moving the N ones of the queued access requests to the respective N buffers.

In another aspect, the method of certain exemplary embodiments for increasing throughput between a master and slaves may further include balancing a load associated with the queued access requests by moving at least one of the second ones of the queued access requests from the second buffer to the first buffer if the accumulated number of access requests in the first buffer becomes less than the accumulated number of access requests in the second buffer.

According to certain exemplary embodiments, an arrangement is provided for increasing throughput between a master and slaves in a multiple interconnect system, and may include a first buffer between the master and the slaves, and the first buffer may include queued access requests to a first and a second one of the slaves. The arrangement may include a second buffer between the master and the slaves, and may further include a control unit coupled to the first buffer and the second buffer to determine a non-balanced condition. The non-balanced condition may be a condition of at least one of the first buffer or one of the slaves. In one aspect, in response to determining the non-balanced condition the controller may transfer ones of the queued access requests associated with the second one of the slaves to the second buffer.

According to certain exemplary embodiments, an arrangement is provided for increasing throughput between a master and slaves in a multiple interconnect system, and may include a first buffer means for queuing first access requests between the master and a first of the slaves and second slave requests between the master and a second of the slaves, and a second buffer means for queuing at least second access requests between the master and the second of the slaves. The arrangement may further include control means for detecting at least one given condition of at least the first buffer means and, in response, for transferring at least one of the second slave requests queued in the first buffer means to the second buffer means.

According to certain exemplary embodiments, a computer product is provided, the computer product having a computer readable medium having instructions that, when read and executed by a processor, cause the processor to perform an operation for increasing throughput between a master and slaves, and the instructions may include instructions that cause the processor to determine a backpressure condition in a first buffer coupled between at least one master and at least a first slave and a second slave, the backpressure condition associated with an accumulated number of access requests, between the master and at least one of the slaves, queued in the first buffer, instructions that, when read and executed by a processor, cause the processor to relieve the determined backpressure condition by identifying access requests associated with the second slave queued in the first buffer, establishing a second buffer coupled between said at least one master and at least the second slave, and moving at least one of the access requests associated with the second slave queued in the first buffer from the first buffer to the second buffer.

According to certain exemplary embodiments a method relates to a first buffer coupling a master to each of a first slave and a second slave, and includes a step for the first buffer to receive a stream of access requests from the master, the stream having first access requests associated with a first slave and second access requests associated with a second slave. The method may include a step for determining a condition of least one of the first buffer or the second slave, and may include a step for relieving the condition, and the relieving may include a step for establishing a second buffer coupling the master to the second slave, a step for identifying second access requests in the accumulated in the first buffer, and a step for moving at least one of the identified second access requests to the second buffer.

### BRIEF DESCRIPTION OF THE DRAWINGS

The accompanying drawings are presented to aid in the description of embodiments of the invention and are provided solely for illustration of the embodiments and not limitation thereof.

FIG. 1 is a diagram illustrating a conventional dual link interconnection in a bus aggregation system.

FIG. 2 is a diagram illustrating functions with respect to a master and slaves performed by a link interconnection in a bus aggregation system.

FIG. 3 is a diagram illustrating a pressure state of queued access requests in a conventional access request buffer in a conventional single link interconnection in a bus aggregation system.

FIGS. 4A-4C show respective access request queuing and backpressure states on a functional block diagram of an example system according to one exemplary embodiment, and related monitoring and controlling of buffer load balance and slave device starvation states.

FIG. 5 is a flow chart illustrating a simplified monitoring an access request buffer and an exemplary bypass buffer in a single link interconnection according to one exemplary embodiment.

FIG. 6 is a functional block diagram of one example communication system.

### DETAILED DESCRIPTION

Aspects of the invention are disclosed in the following description and related drawings showing specific examples having various exemplary embodiments of the invention. Alternate embodiments may be apparent to persons of ordinary skill in the pertinent arts upon reading this disclosure, and may be constructed and practiced without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The term “buffer” can mean a storage element, register or the like or can represent a structure that is implemented by way of instructions that operate on a processor, controller or the like.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

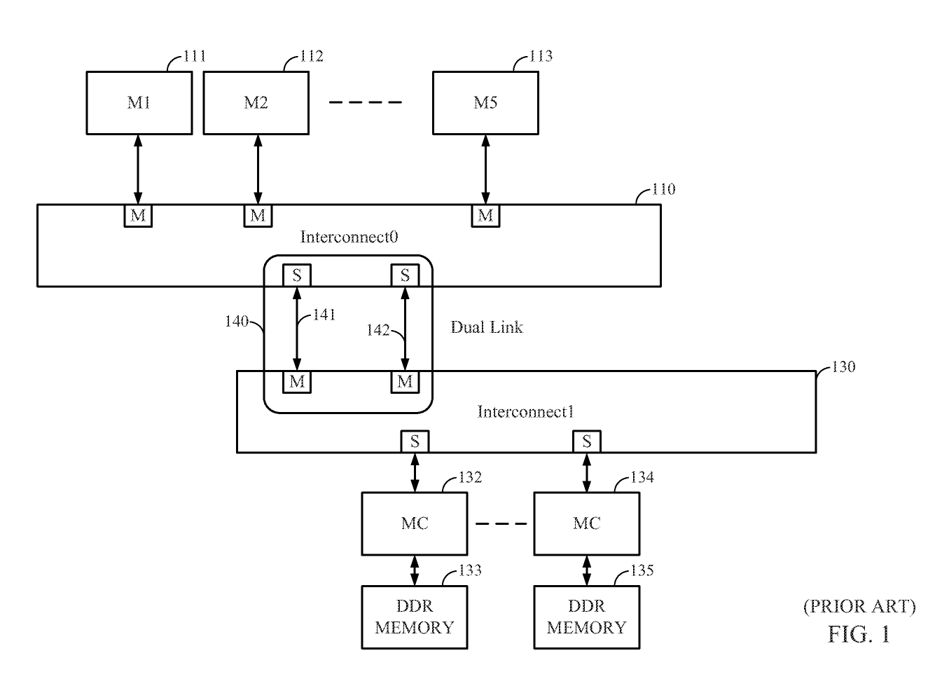

In existing bus aggregation systems, an example of which is shown in FIG. 1, a first set of masters, for example masters M1, M2 . . . M5, labeled as items 111, 112 and 113, respectively, can be connected to a bus or an interconnect such as Interconnect0 110. Slave devices, including memory controller (MC) and double data rate (DDR) memory devices such as MC 132 and DDR memory 133, MC 134 and DDR Memory 135 can be coupled to another interconnect or bus such as Interconnect0 130. Since Interconnect0 110 has more devices, it is more likely that the traffic from Interconnect0 110 to Interconnect1 130 will be greater and also likely that a larger number of access requests can be made, for example, from masters M1 111, M2 112 and M5 113 to slaves MC 132, DDR memory 133, MC 134, and DDR Memory 135 resulting in a backup condition.

Conventional approaches to address the backup condition include the use of a dual link 140 to couple Interconnect0 110 to Interconnect1 130 through two links 141 and 142. Disadvantages arise in that each link is independent and therefore requires separate hardware and system overhead. In addition, unless each link is running at or near full capacity, the utilization is not efficient.

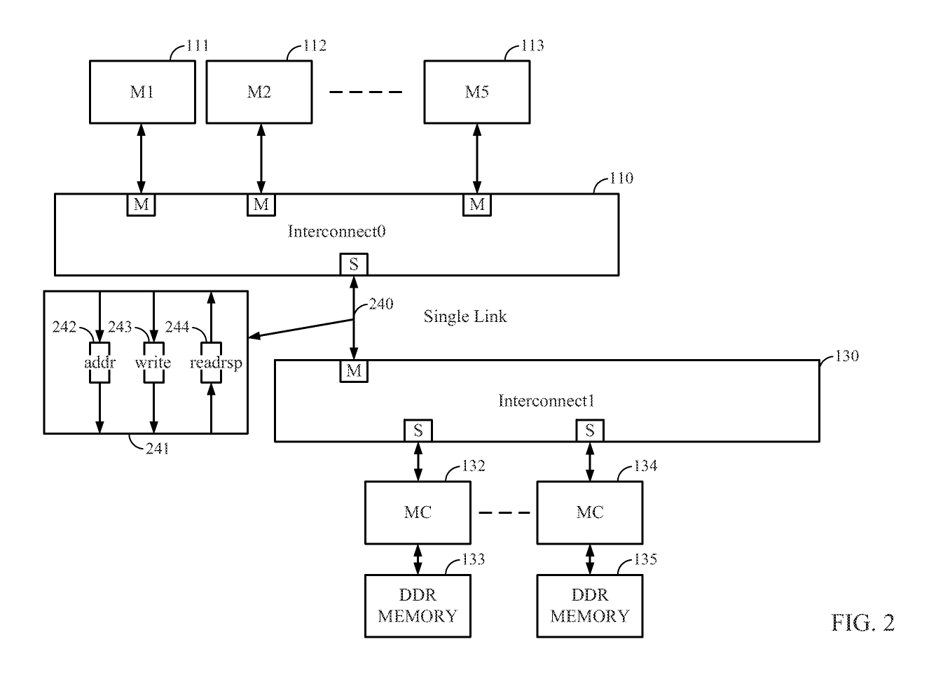

FIG. 2 depicts the functions with respect to master devices and slave devices that must be performed by a single link interconnect. Referring now to FIG. 2, Interconnect0 110 and Interconnect1 130 are coupled by a single link 240 that must carry, from master devices to slave devices, a group 241 of access requests such as an address request addr 242, write request write 243, and in an upstream direction from slave devices to master devices, read response readrsp 244. It will also be appreciated that the access requests such as the address request addr 242 and the write request write 243 can be used by one or more of the masters to either write data or read data from one or more of the slave devices. The read response readrsp 244 can be, for example, the response to an access request to read the contents of an address or the like.

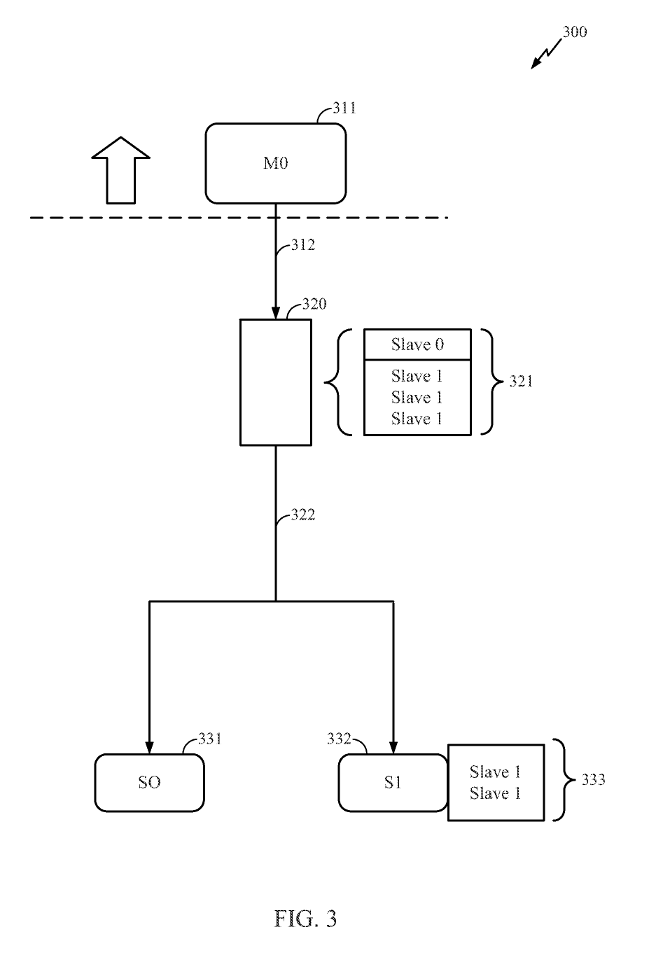

FIG. 3 shows a pressure state of queued access requests in an illustrative model 300 of a conventional access request buffer in a conventional single link interconnection.

Referring now to FIG. 3, in the model 300 an exemplary master M0, labeled as item 311, can be coupled through a connection leg 312, which can be a physical or virtual connection to access request buffer 320. The access buffer 320 can have a queue 321 of elements representing access requests destined for particular ones of the slave devices, such as slave device S0 331 and slave device S1 332. It will be noted that in the example pressure state shown by the queue 321 in FIG. 3, there are three access requests addressed to slave device S1 332 and only a single access request for Slave S0 331. In other words, the accumulated number of access requests addressed to Slave S1 332 in the queue 321 is three and the accumulated number of slave access requests addressed to slave device S0 331 in the queue 321 is one. It will also be understood that the respective accumulated number, or quantities of access requests identified for the FIG. 3 example are only illustrative, as the quantities of access requests at any given instant in an actual conventional single link may be mach higher. Such a condition could cause backpressure, depending on the size of access request buffer 320.

Still referring to FIG. 3, the access request buffer can be coupled to the slaves, such as slave device S0 331 and slave device S1 332 through a connection 322. As can be seen, S1 332 contains two access requests in slave queue 333, which would cause further processing of requests in buffer 320 to back up until the queue for slave device S1 332 is cleared. Meanwhile, the queue (not shown) of S0 331 is empty while an access request waits in queue 321 until the traffic (i.e., the three access requests for slave device S1 332 also in queue 321) clears, creating a starvation condition.

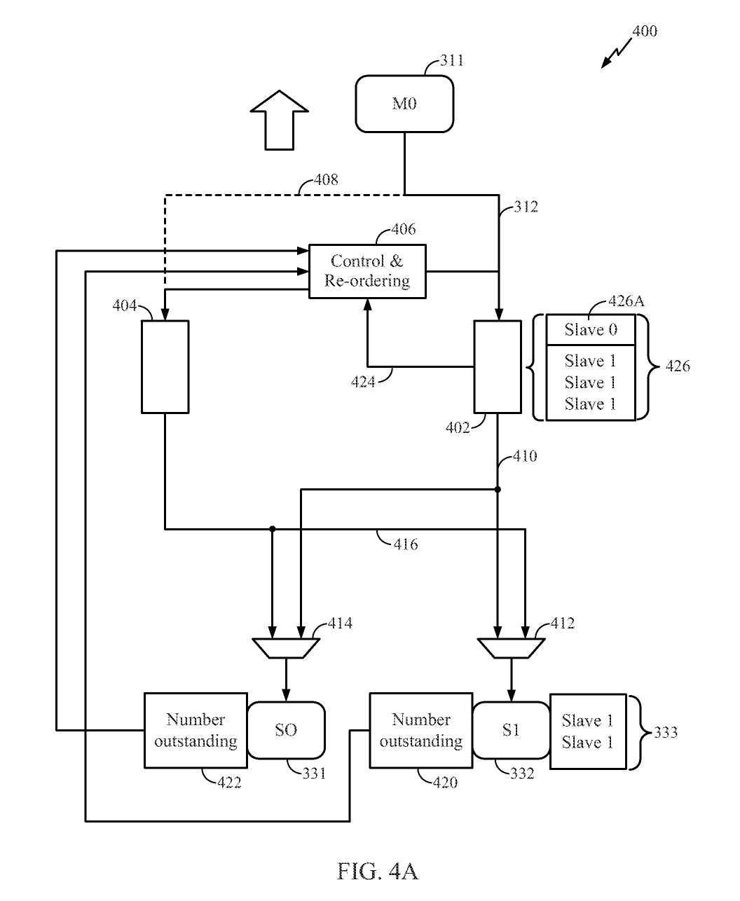

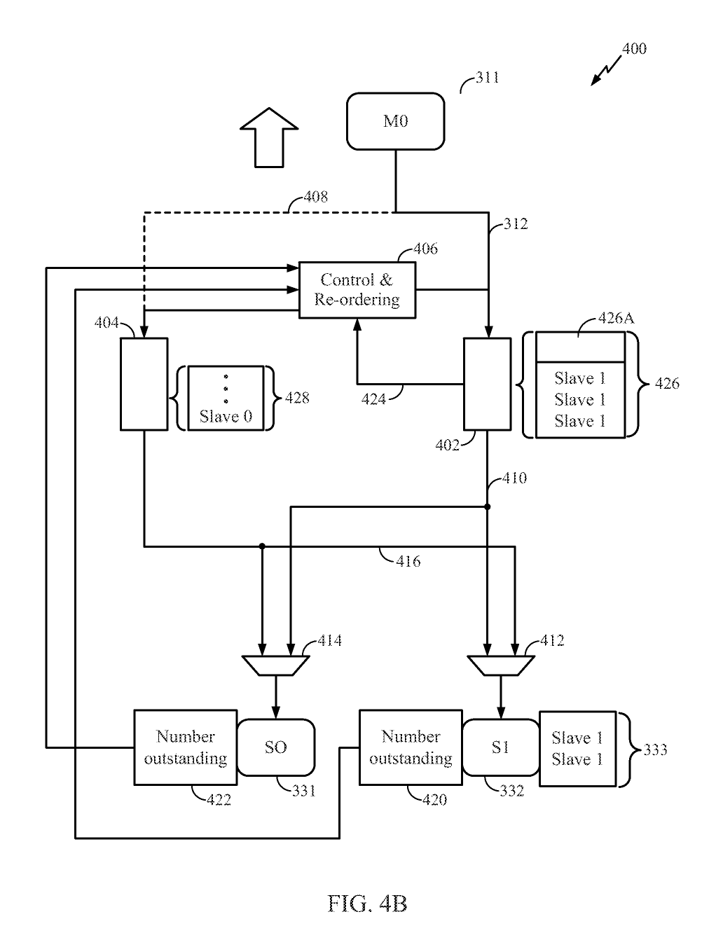

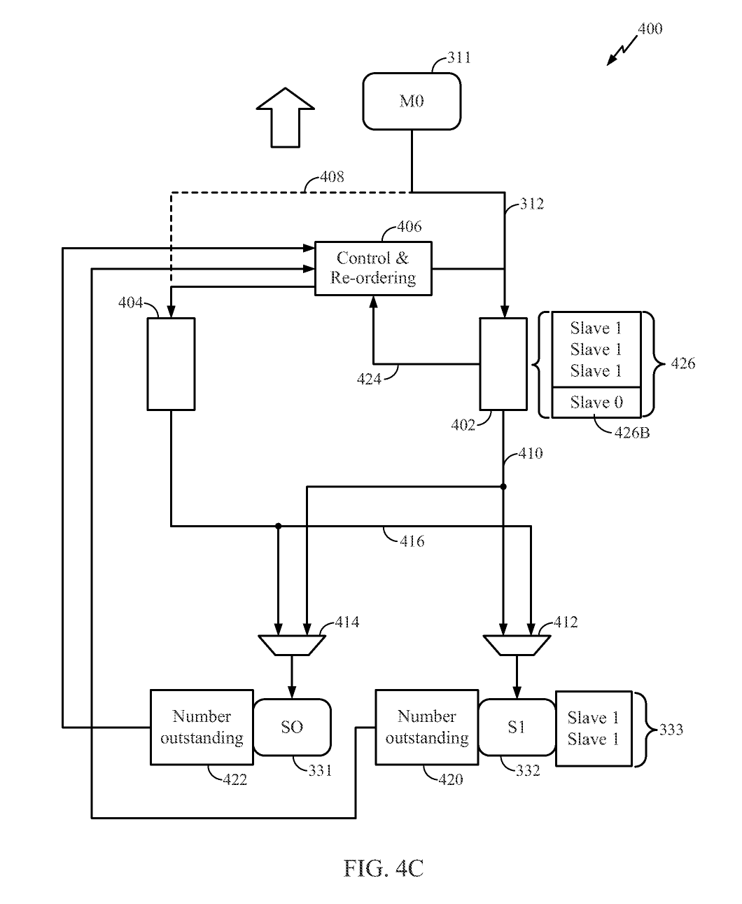

FIGS. 4A-4C show a system 400 according to one exemplary embodiment, and various aspects of buffer load balancing and related reduction of slave device starvation.

Referring now to FIG. 4A, the example system 400 includes a first buffer labeled for purposes of description as an access request buffer 402, and a second buffer labeled for purposes of description as a bypass buffer 404. Hereinafter, the phrase “downstream buffer(s)” is a generic reference, encompassing either, or the collection of the access request buffer 402 and the bypass buffer 404. The access request buffer 402 and the bypass buffer 404 are each coupled to, or capable of being coupled via by leg 312 and interconnect0 to master M0 311. In one aspect bypass buffer 404 may be directly coupled through leg 408 to the Interconnect0. In another aspect, access requests from the master M0 311 may be input to the bypass buffer through a transfer/re-ordering controller 406, described in greater detail at later sections of disclosure may control loading of access requests into the bypass buffer 404.

According to another aspect, access request buffer 402 may function as a primary buffer and bypass buffer 404 may be established only when a backpressure condition or a slave starvation condition is detected, as later described in greater detail. According to another aspect, a downstream buffer designated to function as the access request buffer 402 and one or more downstream buffers designated to function as the bypass buffer 404 may be interchangeable, and in combination with the control/re-ordering function block 406, access requests may be transferred between these downstream buffers to balance their respective loads, and/or to reduce a slave starvation.

With continuing reference to FIG. 4A, access request buffer 402 connects through leg 410 to a first input/output (not separately labeled) of a first 2:1 multiplexer 412 into slave device S1 332, and to a first input/output (not separately labeled) of a second 2:1 multiplexer 414 into slave device S0 331. The bypass buffer 404 connects through leg 416 to a second input/output of the first 2:1 multiplexer 412 into the slave device S1 332, and leg 416 also connects to a second input of the second 2:1 multiplexer 414 into slave device S0 331.

With respect to various implementations of the transfer/re-ordering controller 406, the 2:1 multiplexer blocks 412 and 414, and other blocks depicted in FIGS. 4A-4C represent functions, and do not necessarily represent a separate hardware or hardware segmentation. For each block of the system 400 of FIGS. 4A-4C, various architectures, arrangements and methods of implementation may be readily identified and constructed by persons of ordinary skill having view of this disclosure and, therefore, further detailed description of specific implementations will be omitted.

Referring still to FIG. 4A, slave device access queue monitor (SQM) 420 is a monitor function that may, for example, be connected to or embedded within slave device S1 332. The SQM 420 monitors or detects the number, if any, of outstanding access requests waiting in a queue, stack, or other instruction buffer (referenced collectively hereinafter as a “slave device access queue”) associated with that slave device. In the FIG. 4A depicted access request queuing state of the system 400, slave device S1 332 has a queue 333 of two Slave1 requests, described later in greater detail. SQM 422 is, likewise, a slave device access queue monitor or equivalent function that may, for example, be connected to or embedded within slave device S0 331 that monitors or detects the number of outstanding access requests waiting in its slave device access queue. In the FIG. 4A example access request queuing state of the system 400, slave device S0 331 has no queue of outstanding access requests. Through SQMs 420 and 422 providing these respective numbers of queued access requests to the transfer/re-ordering controller 406, this may be detected as a slave device starvation condition, which is described later in greater detail.

Referring to FIG. 4A, SQM 420 and SQM 422 feed their respective monitoring results to the transfer/re-ordering controller 406. Therefore the transfer/re-ordering controller 406 knows the number, if any, of outstanding access requests waiting in the queue, stack, or other instruction buffer of or associated with, the respective slave devices S0 331 and S1 332. In one aspect, a backpressure condition of the access request buffer 402, shown as 424, is detected and provided to the transfer/re-ordering controller 406.

Referring still to FIG. 4A, according to one aspect the transfer/re-ordering controller 406, upon detection of a given starvation condition of one of the slave devices S0 331 and S1 332 that it monitors, identities within the queue 426 of access buffer 402 access requests, if any, directed to that starved slave device. In the example access request queuing conditions depicted in FIG. 4A, slave device S0 331 is the starved device, at least in relation to slave device S1 332. However even though slave device S0 331 is a starved slave device, within queue 426 of the access request buffer 402 there is at least one slave device access request directed to that starved slave device. As depicted, one of these Slave0 access requests is sitting at position 426A of the queue 426. According to one aspect, the transfer/re-ordering controller 406 detects the FIG. 4A starved. condition of the slave device S0 331 via the monitor 422. In one example system or method according to the present embodiments, in response to detecting conditions such as a slave device starvation condition, the transfer/re-ordering controller 406 using, for example, the detected backpressure 424, transfers from the access request buffer 402 to the bypass buffer 404 access requests directed to the starved slave device. A further aspect may perform re-ordering of one or more access request queues (e.g., queue 426), to expedite delivery of access requests from the buffer queues to the starved slave device.

Referring now to FIG. 4B, one illustrative access request transfer according to this aspect is shown. The transfers, as can be seen from the resulting state of the access buffer 402 queue 426 and the queue 428 of the bypass buffer 404, move the Slave0 access request shown at the FIG. 4A position 426A of the queue 426 to a position (not separately labeled) in the queue 428 of the bypass buffer 404. As will be understood by persons of ordinary skill in view of this disclosure, one example construction of the bypass buffer may be, but is not necessarily, a simple first-in-first out buffer, whereupon the control/re-ordering functional block 406 may simply input the transferred Slave0 access request. In one aspect, the bypass buffer 404 may have a re-orderable queue. According to this aspect, as previously described in reference to the access request buffer 402 queue 426, the control/re-ordering functional block 406 may determine the position in the bypass buffer 404's queue to which an access request is placed, after transfer from the access request buffer 402.

Referring still to FIG. 4B, it will be understood that the transfer/re-ordering controller 406 may transfer one or more of the Slave0 access requests from the access request buffer 402 to the bypass buffer in response to any one of the following two conditions: i) the total number of access request in the access request buffer 402 queue 426 meets a given backpressure condition (e.g., exceeds a given backpressure criterion), or ii) a starvation condition is detected in the slave device S0 331, combined, with one more Slave0 access requests sitting in the queue 426. In one aspect, the transfer/re-ordering controller 406 may perform such transfers until the detected condition is relieved. In another aspect, the transfer/re-ordering controller 406 may perform such a transfer of access requests from the access request buffer 402 to the bypass buffer 404 in a manner determined, at least in part, by a detected extent of either, or both, of the backpressure or starvation conditions. For example, in response to the transfer/re-ordering controller 406 detecting a starvation condition in the slave device S0 331, and detecting the FIG. 4A depicted state of four Slave device access requests in the queue 426 of the access request buffer 402 the transfer/re-ordering controller 406 may transfer two or three, but not necessarily all of these Slave device access requests from the access buffer 402 to the bypass buffer 404.

Referring now to FIG. 4C, according to another aspect, the transfer/re-ordering controller 406 may reduce a slave device starvation condition, such as the previously described starvation condition of the slave device S0 331, by reordering the queue 426 of the access buffer 402 to move an access request directed to that slave device to a lower latency position in that queue. In the FIG. 4C example, the transfer/re-ordering controller 406, in addition to re-ordering the access request buffer 402 queue 426, moves the Slave device access request from position 426A shown in FIG. 4A to the lower waiting position 426B previously occupied by a Slave1 access request.

It will be understood that further to the re-ordering and transfer aspect illustrated at FIG. 4C, the transfer/re-ordering controller 406 controls the 2:1 multiplexers 412 and 414 to select between the bypass buffer 404 and the access request buffer 402 to receive their respective Slave1 or Slave0 device access requests.

In one aspect, the transfer/re-ordering controller 406 may perform a re-ordering of access requests in the queue 428 shown in FIG. 4B of the bypass buffer 404, in addition to the previously described transfer of access requests from the access request buffer 402 and re-ordering of access requests within the queue 426.

Referring to FIG. 4B, in particular to the queue 333 of the slave device S1 332, it will be understood that loading Slave1 access requests into the slave device S1 332 from the access request buffer 402 may be subject to a queuing capacity of the particular device embodying that slave device S1 331.

Referring to FIGS. 4A-4C, all of the above-described examples identify the starvation condition of the slave device S0 331 as a zero outstanding access request number from the monitor 422. It will be understood, though, that a starvation condition may be defined by a threshold number of outstanding access requests from 422 (or 420) that is greater than zero.

Further, the example system 400 of FIG. 4A-4C shows only the single bypass buffer 404, but this is only for purposes of describing concepts of the embodiments. Applications practicing these embodiments may have many (e.g., a quantity N greater than two) slave devices present. Therefore, in the absence of bypass buffers according to these embodiments, access requests for up to N different slave devices may be present in the access request buffer 402. In one aspect, (although one bypass buffer such as the example 404 may provide substantial benefit), additional benefit may be obtained by establishing the bypass buffer 404 as a dynamic buffer resource. Further to this aspect, the transfer/re-ordering controller 406 may be readily configured, in view of this disclosure, to establish and control up to N additional bypass buffers, e.g., to perform required buffer-to-buffer transfers of access requests and re-ordering of the buffer queues in response to detected backpressure conditions and/or slave device starvation conditions.

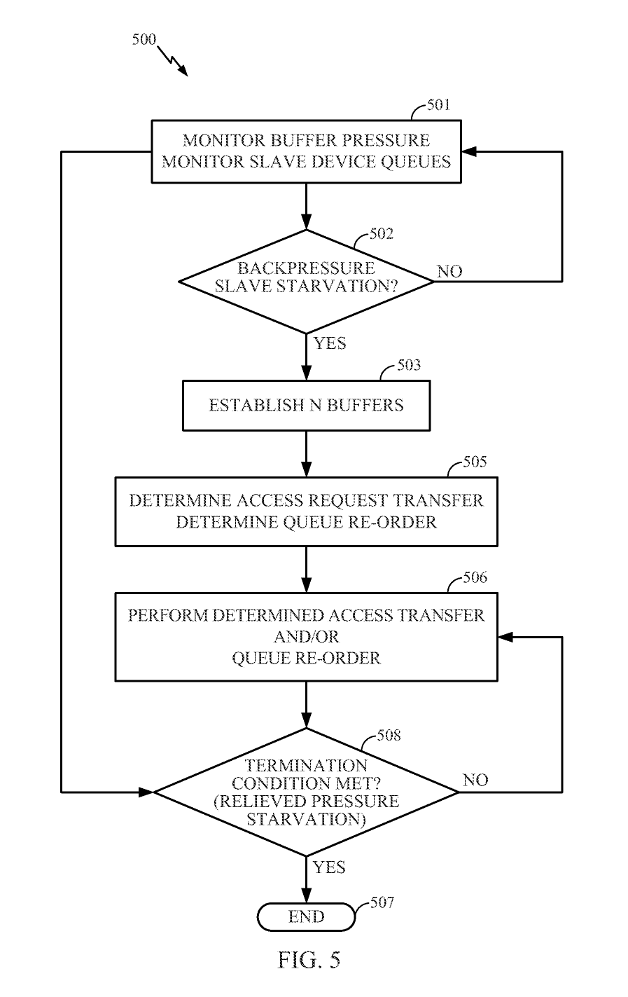

FIG. 5 is a flow chart illustrating an exemplary process 500 of one method according to the present embodiments, in a single link interconnection according to one exemplary embodiment. Illustrative example operations of process 500 will be described in reference to FIGS. 4A-4C. It will be understood that the FIG. 5 flow chart assumes that under normal conditions, where a backpressure condition is not present, and no starvation condition is detected in any of the slave devices, the access request buffer 402 may be a primary buffer to which all access requests may be directed, regardless of the slave device to which the access request is directed.

Referring to FIG. 5, the process 500 starts at 501 where it monitors a pressure state, for example a backpressure 424 of the access buffer 402 and, (for example, by way of monitors 420 and 422 monitoring a number of outstanding access request in the slave device access queues) a starvation status of the slave devices S0 331 and S1 332. At 502, if a backpressure condition of the access request buffer 402, or a starvation condition or slave device S0 331 or slave device S1 332 is determined, then a YES sends the process to 503. If 502 is NO then 501 continues. As previously described, one example backpressure condition may be the number of outstanding queued access requests in the access request buffer 402 access buffer queue 426 exceeding a specified value backpressure condition value. As also previously described, a slave device starvation condition may be the number of outstanding access requests indicated by monitor 422, or by monitor 420, being below a given threshold. If either or both of the backpressure condition or slave device starvation condition is determined to exist at 502, then the process goes to 503 and a bypass buffer, such as bypass buffer 404, may be established.

Referring still to FIG. 5, after 503 establishes the bypass buffer 404 or N bypass buffers functioning as 404, the process 500 goes to 505, where a transfer/re-ordering determination is performed. In one aspect, transfer/re-ordering determination 505 is for the control/re-ordering device 406 may perform one or more transfers of access requests, e.g., from the access request buffer 402 to the bypass buffer 404, in an iterative manner until the condition detected at 502 is relieved. In another aspect, the control/re-ordering device 406 may determine, based on the particular detected backpressure condition of the access request buffer 402 and the particular detected starvation state of the slave devices, a corresponding particular direction and amount for changing the queuing state among the access request buffer 402 and the bypass buffer 404 of different access requests (e.g., Slave device and Slave1 access requests). Further to this aspect, the control/re-ordering device 406 may perform transfers of access requests, and re-orderings of queues, until the determined object state is reached, or until the condition detected at 502 is relieved.

With continuing reference to FIG. 5, in one aspect a transfer/re-ordering determination at 505, may weigh or may apply an equivalent of weighing one or more relevant factors such as processing overhead to perform a re-ordering, the number N of bypass buffers, the relative proportion in particular queues between the number of access requests to different ones of the slave devices and, in one aspect, a weighing of different priority among different slave devices and/or different priority among different types of access requests.

Referring to FIG. 5, after the transfer/re-ordering determination 505, the process goes to 506 where it performs the transfer(s) of access requests among the downstream buffers (e.g. between access request buffer 402 and bypass buffer 404 and re-ordering(s) of buffer queues, in the access request buffer 402 and, in one aspect, in bypass buffers established at 503. In one aspect, the 506 transfer and/or re-ordering operations may continue until at 508 a given termination condition is met. In one aspect the 508 termination condition may be a relief of the condition detected at 502, at least to a given relief criterion. Further to this aspect, the 506 transfer and/or re-ordering operations continue until at 508 the given termination condition is met. In one aspect, during the 506 transfer and/or re-ordering operations the condition detecting 502 may continue and, in additional aspect, the control/re-ordering device 406 may change the scheme determined at 505.

As one example alternative termination condition 508 in practicing according to the embodiments, assume an application in which the access request buffer 402 can be assigned to a particular slave device, for example slave device S1 332. Also assume in this example that at 505 it is determined that the condition detected at 502 will be relieved by purging the access request buffer 402 of all access request that are not directed at the slave device to which that access request buffer 402 is assigned. In one example of such purging according to this embodiment, the purging begins with determining which slave device has the predominant number of requests in that the queue (e.g. queue 426) of the access request buffer (e.g. the access request buffer 402). In the FIG. 4A example 400, Slave1 access requests have the predominant number in the queue 426 of the access request buffer 402. Therefore, in an example according to this embodiment, access request buffer 402 would first be assigned to the slave device S1 332, and the queue 426 would then be purged of all access requests other than Slave1 access requests. Under this assumption, the termination condition 508 is the purge being completed, i.e., the access buffer 402 having no access requests directed to another slave device. Therefore, the purging being complete corresponds to a YES at 508, and the process terminates at 507.

Continuing with this example, if the transfer/re-ordering determination 505 determines the backpressure condition or slave device starvation condition would not be relieved by such purging, the transfer/re-ordering determination 505 may choose or apply a different algorithm or scheme of transferring access request between the downstream buffers and/or re-ordering certain buffer queues.

It will further be appreciated that while the process 500 is designated as ending at 507, the process 500 can continue to loop or can be repeated as often as necessary to relieve ongoing or new backpressure conditions.

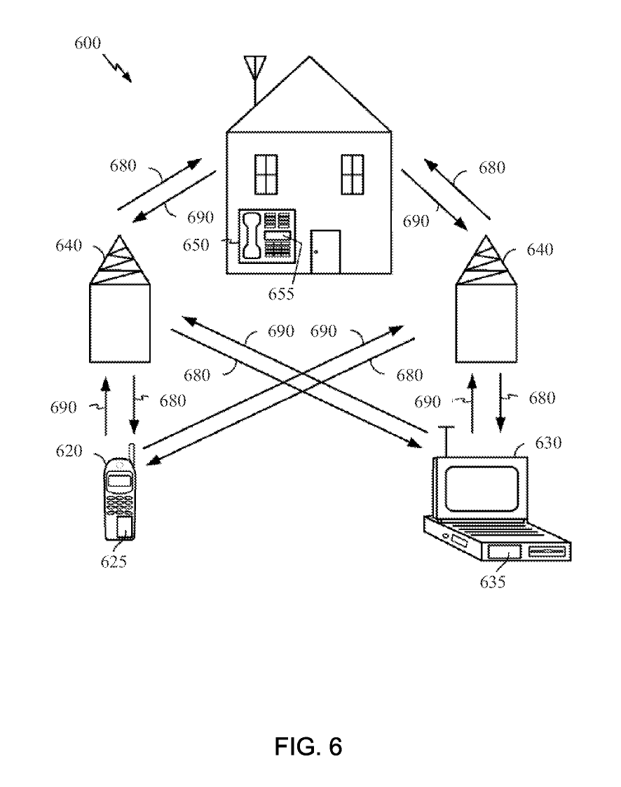

FIG. 6 illustrates an exemplary wireless communication system 600 in which one or more embodiments of the disclosure may be advantageously employed. For purposes of illustration, FIG. 6 shows three remote units 620, 630, and 650 and two base stations 640. It will be recognized that conventional wireless communication systems may have many more remote units and base stations. The remote units 620, 630, and 650 include semiconductor devices 625, 635 and 655 (including on-chip voltage regulators, as disclosed herein), which are among embodiments of the disclosure as discussed further below. FIG. 6 shows forward link signals 680 from the base stations 640 and the remote units 620, 630, and 650 and reverse link signals 690 from the remote units 620, 630, and 650 to the base stations 640.

In FIG. 6, the remote unit 620 is shown as a mobile telephone, the remote unit 630 is shown as a portable computer, and the remote unit 650 is shown as a fixed location remote unit in a wireless local loop system. For example, the remote units may be mobile phones, hand-held personal communication systems (PCS) units, portable data units such as personal data assistants, navigation devices (such as GPS enabled devices), set top boxes, music players, video players, entertainment units, fixed location data units such as meter reading equipment, or any other device that stores or retrieves data or computer instructions, or any combination thereof. Although FIG. 6 illustrates remote units according to the teachings of the disclosure, the disclosure is not limited to these exemplary illustrated units. Embodiments of the disclosure may be suitably employed in any device which includes active integrated circuitry including memory and on-chip circuitry for test and characterization.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for increasing: throughput in a bus aggregation system. Accordingly, the invention is not limited to illustrated examples and any means for performing the functionality described herein are included in embodiments of the invention.

The foregoing disclosed devices and methods are typically designed and are configured into GDSII and GERBER computer files, stored on a computer readable media. These files are in turn provided to fabrication handlers who fabricate devices based on these files. The resulting products are semiconductor wafers that are then cut into semiconductor die and packaged into a semiconductor chip. The chips are then employed in devices described above. Further the above-described slave devices may include a spin transfer torque random access memory (STT-RAM) device.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for transferring access requests between a master and a plurality of slaves, comprising:
providing a first buffer coupling the master to each of a first slave and a second slave;
receiving at the first buffer a stream of said access requests from the master, the stream having first access requests associated with a first slave and second access requests associated with a second slave;
determining a non-balanced condition of at least one of the first buffer or the second slave; and
relieving the non-balanced condition by:
identifying second access requests in the first buffer;
establishing a second buffer coupling the master to said second slave; and
moving at least one of the identified second access requests to the second buffer.

2. The method of claim 1, wherein the access requests include one or more of a read operation and a write operation.

3. The method of claim 1, further comprising deleting the second buffer when the non-balanced condition is relieved.

4. The method of claim 1, wherein the second buffer includes a bypass buffer.

5. The method of claim 1, further comprising queuing the access requests received from the master in the first buffer, and wherein the relieving the non-balanced condition further includes reordering queued access requests in at least the first buffer.

6. The method of claim 1, further comprising queuing in the first buffer the access requests received from the master, wherein moving at least one of the identified. second access requests to the second buffer includes queuing the at least one second access requests in the second buffer, and wherein relieving the non-balanced condition further includes reordering queued access requests in at least one of the first buffer or the second buffer.

7. The method of claim 1, further comprising the queuing in the first buffer the access requests received from the master, wherein moving at least one of the identified second access requests to the second buffer includes queuing the at least one second access request in the second buffer, wherein relieving the non-balanced condition further includes moving first access requests queued in the first buffer from the first buffer to the first slave, and moving second access requests in the second buffer from the second buffer to the second slave.

8. The method of claim 1, wherein the relieving the non-balanced condition further includes:
identifying N ones of the queued access requests in the first buffer associated with accessing respective N ones of the slaves;
establishing N buffers, each coupled between the master and at one of the respective N ones of the slaves; and
moving the N ones of the queued access requests to the respective N buffers.

9. The method of claim 1, wherein the non-balanced condition of the first buffer is a backpressure condition, and wherein determining the non-balanced condition of the first buffer includes comparing an accumulated number of access requests in the first buffer to a given backpressure criterion.

10. The method of claim 1, wherein the non-balanced condition of the first buffer is a backpressure condition, and wherein determining the non-balanced condition of the first buffer includes comparing an accumulated number of second access requests in the first buffer to a given backpressure criterion.

11. The method of claim 1, further comprising the first buffer queuing the access requests received from the master, wherein the non-balanced condition of the second slave is a starvation condition, and wherein determining the starvation condition includes determining a queue position of second access requests queued in the first buffer.

12. The method of claim 1, further comprising the first buffer queuing the access requests received from the master, wherein moving at least one of the identified second access requests to the second buffer includes queuing the at least one second access requests in the second buffer, wherein the non-balanced condition of the second slave is a starvation condition, and wherein determining the starvation condition includes determining at least one of a queue position of second access requests queued in the first buffer or determining a queue position of second access requests queued in the second buffer.

13. A method for increasing throughput between a master and slaves, the method comprising:
determining an availability condition of a first and a second of the slaves;
determining an accumulated number of queued access requests for the slaves queued in a first buffer coupled between the master and at least a first and a second of the slaves, wherein first ones of the queued access requests are associated with the first slave; and
if the accumulated number is greater than a given value and the second slave is determined to be available, then:
identifying second ones of the queued access requests in the first buffer associated with the second slave;
establishing a second buffer associated with the second slave; and
moving at least one of the second ones of the queued access requests to the second buffer.

14. The method of claim 13, wherein the accumulated number includes an accumulated number of the second ones of the queued access requests.

15. The method of claim 13, further comprising deleting the second buffer.

16. The method of claim 13, wherein the method further includes:
identifying N ones of the queued access requests in the first buffer associated with respective N ones of the slaves;
establishing N buffers, each coupled between the master and at least one of the respective N ones of the slaves; and
moving the N ones of the queued access requests to the respective N buffers.

17. The method of claim 13, wherein the second buffer includes a bypass buffer.

18. The method of claim 13, wherein the queued access requests include one or more of a read operation and a write operation.

19. The method of claim 13, further comprising balancing a load associated with the queued access requests by moving at least one of the first ones of the queued access requests to the second buffer.

20. The method of claim 13, further comprising:
balancing a load associated with the queued access requests by moving at least one of the second ones of the queued access requests from the second buffer to the first buffer if the accumulated number of access requests in the first buffer becomes less than the accumulated number of access requests in the second buffer;
determining an availability condition of a first and a second of the slaves;
determining an accumulated number of queued access requests for the slaves queued in a first buffer coupled between the master and at least a first and a second of the slaves, wherein first ones of the queued access requests are associated with the first slave; and
if the accumulated number is greater than a given value and the second slave is determined to be available, then:
identifying second ones of the queued access requests in the first buffer associated with the second slave;
establishing a second buffer associated with the second slave; and
moving at least one of the second ones of the queued access requests to the second buffer.

21. The method of claim 13, further comprising determining a starvation condition of the second slave, wherein said determining a starvation condition includes determining a respective queue position of at least one of the second ones of the queued access requests in the first buffer and, based on at least one of said respective queue positions, moving at least one of the second ones of the queued slave requests in the first buffer to the second buffer.

22. The method of claim 13, further comprising determining a starvation condition of the second slave, wherein determining the starvation condition includes determining a respective queue position of at least one of the second ones of the access requests queued in the first buffer or a respective queue position of at least one of the second access requests queued in the second buffer and, based on at least one of said determined queue positions, moving at least one of the second ones of the queued slave requests in the first buffer to the second buffer.

23. The method of claim 13, further comprising determining a starvation condition of the second slave, wherein determining the starvation condition includes determining a respective queue position of at least one of the second ones of the access requests queued in the first buffer or a respective queue position of at least one of the second access requests queued in the second buffer and, based on at least one of said determined queue positions, moving at least one of the second ones of the queued slave requests in the second buffer to the first buffer.

24. An arrangement for increasing throughput between a master and slaves in a multiple interconnect system, the arrangement comprising:
a first buffer between the master and the slaves, the first buffer located downstream of the master, the first buffer including queued access requests to a first and a second one of the slaves;
a second buffer between the master and the slaves, the second buffer located downstream of the interconnect; and
a control unit coupled to the first buffer and the second buffer to determine a non-balanced condition, the non-balanced condition being a condition of at least one of the first buffer or one of the slaves and, in response, to transfer ones of the queued access requests associated with the second one of the slaves to the second buffer.

25. The arrangement of claim 24, wherein the condition of the first buffer includes a backpressure condition of the first buffer.

26. The arrangement of claim 24, wherein the condition of the first buffer includes that a number of the queued access requests exceeds a given value.

27. The arrangement of claim 24, wherein the condition of the first buffer includes a given value of an accumulated number of the second ones of the queued access requests.

28. The arrangement of claim 24, wherein the control unit further:
identifies N ones of the queued access requests in the first buffer associated with accessing respective N ones of the slaves;
establishes N buffers, each coupled between the master and at least one of the respective N ones of the slaves; and
transfers the N ones of the queued access requests to the respective N buffers.

29. The arrangement of claim 24, wherein the second buffer includes a bypass buffer.

30. The arrangement of claim 24, wherein the queued access requests include one or more of a read operation and a write operation.

31. The arrangement of claim 24, wherein the non-balanced conditions include a non-balanced load condition associated with the queued access requests and the control unit, in response to determining the non-balanced load condition, balances a load associated with the queued access requests by moving at least one of the first ones of the queued access requests to the second buffer.

32. The arrangement of claim 21, wherein the non-balanced conditions include a non-balanced load condition associated with the queued access requests, and wherein the control unit relieves the non-balanced load condition by balancing a load associated with the queued access requests by moving some of the second ones of the queued access requests from the second buffer to the first buffer if the accumulated number of access requests in the first buffer becomes less than the accumulated number of access requests in the second buffer.

33. The arrangement of claim 24, wherein the arrangement is integrated in at least one semiconductor die.

34. The arrangement of claim 24, further comprising a device, selected from the group consisting of a settop box, music player, video player, entertainment unit, navigation device, communications device, personal digital assistant (PDA), fixed location data unit, and a computer, into which the arrangement is integrated.

35. The arrangement of claim 24, wherein the control unit further determines a starvation condition of the second slave, wherein said determining a starvation condition includes determining a respective queue position of access request to the second slave queued in the first buffer and, based on at least one of the respective queue positions, moving at least one of the second ones of the access requests to the second slave queued in the first buffer to the second buffer.

36. The arrangement of claim 24, wherein the control unit queues in the second buffer ones of the queued access requests associated with the second one of the slaves the control unit transfers from the first buffer to the second buffer, wherein the control unit further determines a starvation condition of the second slave, wherein determining the starvation condition includes determining a respective queue position of access requests to the second slave queued in the first buffer or a respective queue position of access requests to the second slave queued in the second buffer, and wherein the control unit, based on at least one of said determined queue positions, moves at least one of the second ones of the queued slave requests in the first buffer to the second buffer.

37. The arrangement of claim 24, wherein the control unit queues in the second buffer ones of the queued access requests associated with the second one of the slaves the control unit transfers from the first buffer to the second buffer, wherein the control unit further determines a starvation condition of the second slave, wherein determining the starvation condition includes determining a respective queue position of access requests to the second slave queued in the first buffer or a respective queue position of access requests to the second slave queued in the second buffer, and wherein the control unit, based on at least one of said determined queue positions, moves at least one of the second ones of the queued slave requests in the second buffer to the first buffer.

38. An arrangement for increasing throughput between a master and slaves in a multiple interconnect system, the arrangement comprising:
first buffer means for queuing first access requests between the master and a first of the slaves and second slave requests between the master and a second of the slaves;
second buffer means for queuing at least second access requests between the master and the second of the slaves; and
control means for detecting at least one given condition of at least the first buffer means and, in response, transferring at least one of the second slave requests queued in the first buffer means to the second buffer means.

39. The arrangement of claim 38, wherein the given condition of the first buffer means includes a backpressure condition.

40. The arrangement of claim 38, wherein the given condition of the first buffer means includes a backpressure condition, wherein the backpressure condition includes that a number of at least the second slave requests queued in the first buffer means exceeds a given value.

41. The arrangement of claim 38, wherein the given condition of the first buffer means includes a backpressure condition, wherein the backpressure condition includes that a number of at least the first slave requests or at least the second slave requests queued in the first buffer means exceeds a given value.

42. The arrangement of claim 38, wherein the first buffer means is further for queuing access requests between the master and any one of N slaves, wherein the control means is further for:
identifying the slave associated with each of the access requests queued in the first buffer;
establishing, based on said identifying, N buffers, each coupled between the master and at least one of the respective N ones of the slaves; and
transferring at least one of access requests queued in the first buffer means to a respective one of the N buffers, based on the respective one of the N slaves identified as associated with the at least one access request.

43. The arrangement of claim 38, wherein at least one of the first access requests or at least one of the second access requests includes one or more of a read operation and a write operation.

44. The arrangement of claim 38, wherein the control means is further for balancing, based on a given load criterion, a load associated with at least one of the first access requests or second slave requests queued in the first buffer means, wherein the balancing includes moving, based at least in part on the given criterion, at least one of the second access requests from the first buffer means to the second buffer means.

45. The arrangement of claim 38, wherein the control means is further for balancing a load associated with at least one of the first access requests or the second access requests queued in the first buffer means by moving at least one of the queued second access requests from the second buffer means to the first buffer means if an accumulated number of first or second access requests queued in the first buffer means becomes less than an accumulated number of first or second access requests queued in the second buffer means.

46. The arrangement of claim 38, wherein the arrangement is integrated in at least one semiconductor die.

47. The arrangement of claim 38, further comprising a device, selected from the group consisting of a settop box, music player, video player, entertainment unit, navigation device, communications device, personal digital assistant (PDA), fixed location data unit, and a computer, into which the arrangement is integrated.

48. The arrangement of claim 38, wherein the control means is further for determining a starvation condition of the second slave, wherein said determining a starvation condition includes determining a respective queue position of at least one of the second ones of the queued access requests in the first buffer and, based on at least one of said respective queue positions, moving at least one of the second ones of the queued slave requests in the first buffer to the second buffer.

49. The arrangement of claim 38, wherein the control means is further for determining a starvation condition of the second slave, wherein determining the starvation condition includes determining a respective queue position of at least one of the second ones of the access requests queued in the first buffer or a respective queue position of at least one of the second access requests queued in the second buffer and, based on at least one of said determined queue positions, moving at least one of the second ones of the queued slave requests in the first buffer to the second buffer.

50. The arrangement of claim 38, wherein the control means is further for determining a starvation condition of the second slave, wherein determining the starvation condition includes determining a respective queue position of at least one of the second ones of the access requests queued in the first buffer or a respective queue position of at least one of the second access requests queued in the second buffer and, based on at least one of said determined queue positions, moving at least one of the second ones of the queued slave requests in the second buffer to the first buffer.

51. A computer product having a computer readable medium comprising instructions that, when read and executed by a processor, cause the processor to perform an operation for increasing throughput between a master and slaves, the instructions comprising:
instructions that, when read and executed by a processor, cause the processor to determine a backpressure condition in a first buffer coupled between at least one master and at least a first slave and a second slave, the backpressure condition associated with an accumulated number of access requests, between the master and at least one of the slaves, queued in the first buffer;
instructions that, when read and executed by a processor, cause the processor to relieve the determined backpressure condition by:
identifying access requests associated with the second slave queued in the first buffer;
establishing a second buffer coupled between said at least one master and at least the second slave; and
moving at least one of the access requests associated with the second slave queued in the first buffer from the first buffer to the second buffer.

52. The computer product of claim 51, wherein the instructions further include instructions that when read and executed by the processor cause the processor to determine a starvation condition of the second slave, by determining a respective queue position of second access requests queued in the first buffer or a respective queue position of second access requests queued in the second buffer and cause the processor to move, based on at least one of said determined queue positions, at least one of the second slave requests queued in the first buffer to the second buffer.

53. The computer product of claim 51, further comprising instructions that when read and executed by the processor cause the processor to balance a load associated with the queued access requests by moving some of the first ones of the queued access requests to the second buffer.

54. A method transferring access requests between a master and a plurality of slaves, comprising:
step for providing a first buffer coupling the master to each of a first slave and a second slave;
step for receiving at the first buffer a stream of said access requests from the master, the stream having first access requests associated with a first slave and second access requests associated with a second slave;
step for determining a non-balanced condition of at least one of the first buffer or the second slave; and
step for relieving the non-balanced condition by:
identifying second access requests in the first buffer;
establishing a second buffer coupling the master to said second slave; and
moving at least one of the identified second access requests to the second buffer.

55. The method of claim 54, further comprising a step for queuing the access requests received from the master in the first buffer, and wherein the step for relieving the non-balanced condition further includes a step for reordering queued access requests in at least the first buffer.

56. The method of claim 54, further comprising a step for queuing in the first buffer the access requests received from the master, wherein the step for moving at least one of the identified second access requests to the second buffer includes a step for queuing the at least one second access requests in the second buffer, and wherein the step for relieving the non-balanced condition further includes a step for reordering queued access requests in at least one of the first buffer or the second buffer.

57. A method for increasing throughput between a master and slaves, the method comprising:
step for determining an availability condition of a first and a second of the slaves;
step for determining an accumulated number of queued access requests for the slaves queued in a first buffer coupled between the master and at least a first and a second of the slaves, wherein first ones of the queued access requests are associated with the first slave; and
step for performing, if the accumulated number is greater than a given value and the second slave is determined to be available, steps for:
identifying second ones of the queued access requests in the first buffer associated with the second slave;
establishing a second buffer associated with the second slave; and
moving at least one of the second ones of the queued access requests to the second buffer.
